(19) United States
(12) Patent Application Publication
(10) Pub. No.: US 2021/0292036 A1
(43) Pub. Date: Sep. 23, 2021

(54) METHOD FOR FEEDING LINERLESS LABELS TO A LABELLING UNIT AND APPARATUS FOR FEEDING LINERLESS LABELS TO THE LABELLING UNIT

(71) Applicant: ILTI S.R.L., CASTELLUCCHIO (IT)

(72) Inventor: TARCISIO SCAPINELLI, CASTELLUCCHIO (IT)

(21) Appl. No.: 17/205,531

(22) Filed: Mar. 18, 2021

(30) Foreign Application Priority Data
Mar. 19, 2020 (IT) 102020000005839

(51) Int. Cl. B65C 9/18; B65C 3/08

(52) U.S. Cl. CPC B65C 9/1807; B65C 2009/0081; B65C 3/08

(57) ABSTRACT

An apparatus for feeding a strip (1) of linerless labels (2) to a drum (60) for applying the labels onto containers comprises a strip support (10) for supporting a reel of a strip of linerless labels (2) and allowing unwinding of the strip (1) from the reel; a first motorized drive roller (20), designed to rotate in a direction of rotation to cause unwinding of the strip (1) arranged on the support (10) and continuous feeding thereof downstream in an advancement direction (X-X) of the strip; a second motorized drive roller (50), designed to rotate such as to cause advancing of the strip (1) towards the drum (60); a chamber (100) which is arranged between the first drive roller (20) and the second drive roller (5) in the direction (X-X) of advancement of the strip; a first upstream roller (11) of the chamber, motorized and rotating in the direction of rotation for advancing the strip, and a second downstream roller (120a) of the chamber, motorized to rotate in a direction opposite to that of the first upstream roller, said rollers being arranged at a respective upstream or downstream edge of the opening (101) of the chamber (100). Pressurized air is fed to a dispensing nozzle (202) arranged to dispense the pressurized air towards the inside of the chamber (100) and a control unit (500) is configured and arranged to cause the unwinding and continuous advancing movement of the strip (1) from the support (10) to the upstream roller (11) of the chamber (100) and an advancing movement of the strip with a predefined speed and tension between said downstream roller (120a,120) of the chamber (100) and the second motorized drive roller (50).

The present invention relates to a method for feeding a strip of linerless labels to a drum of a labeling unit, an apparatus for feeding linerless labels to said labeling unit and a labeling unit comprising such an apparatus.

It is known that in the technical sector of packaging there exists the need to apply to each container containing a product a corresponding identification label.

Also known are apparatus designed to transfer to the container single self-adhesive labels mounted on a backing strip and wound up on a reel, said transfer being performed by means of programmed and controlled sequences for unwinding the reel itself and transferring a label onto the corresponding container which moves on an associated conveying machine.

In the context of this technical sector, also known in particular are so-called “linerless” labels, namely labels which are not mounted on a backing strip to be separated form the label at the time of application of the latter and to be recovered separately for disposal thereof.

These linerless labels essentially consist of a single strip or several laminated sheets of suitable material, one of the opposite surfaces of which is provided with an adhesive layer, which remains exposed during the unwinding process towards the containers onto which they are to be applied, while the other, opposite, surface is coated with a non-adhesive varnish designed to prevent gluing of the continuous strip formed by the said labels joined together, when it is wound up onto itself. The continuous strip may also be provided with perforations (pre-incisions) forming preferred cutting lines designed to allow separation of each label from the respective adjacent labels along the strip.

EP 2,407,390 in the name of the same present Applicant also discloses an apparatus for applying linerless labels by means of a drum designed to apply and cut labels on containers of various kinds.

The application of labels onto containers arranged on means normally rotating at a very high speed requires however that the strip of labels should be fed to the separation and application drum with predefined speeds and, in particular, a constant tension to avoid jamming and/or the arrival of the labels on the drum in a wrong position with respect to the correct reference position for cutting and separating them.

In order to ensure said feeding of the strip with a constant tension it is also known from EP 2,212,207 to insert a tunnel between a strip unwinding reel and a drive roller for feeding the said strip to the application and cutting drum.

Along its travel path the strip is made to pass into the tunnel which has associated air suction means which result in the formation of a loop, of variable length, suitable for performing a flywheel function for the strip entering and leaving the tunnel; in this way any variations in speed of the strip along the travel path as far as the drive roller are taken up by the tunnel which ensures that the advancing strip has a constant tension.

Although practical for labels with a backing strip, the known tunnel however, is not suitable for application of linerless labels.

The processing of linerless labels, namely labels without a backing strip and with one side entirely coated with adhesive, generally also provided with perforations for easy separation, nevertheless poses further difficulties.

In particular, the adhesive side may tend to become glued, during the feeding movement, both onto parts of the machine and onto itself, in particular in the zone were the loop of strip with the two adhesive sides facing each other is formed.

Moreover, this feeding of the strip of linerless labels at a predefined speed and tension for application onto containers is generally performed in an intermittent or variable continuous manner, and therefore subject to starting and stopping and/or accelerations and decelerations.

Managing the sudden starting and stopping which is typical of production, while keeping the tension of the strip being fed towards the application drum constant, subjects the strip to major accelerations (e.g. from 0 to 130 m/min. along 10-15 mm of strip) which could favour gluing and/or generate breakages, much more likely in the case of linerless labels which have micro-perforations and therefore are fragile.

DE 10 2014 105 485 describes a labeling machine with a rotating drum for applying labels onto respective containers, to which a strip of linerless labels is fed, which labels may be pre-glued or coated with adhesive before they are fed to the drum. The strip is unwound from a reel mounted on support means by means of a transfer cylinder which is arranged immediately upstream of and in contact with the application drum and cooperates tangentially with a cutting cylinder designed to make a series of perforations in the strip so as to allow the easy separation of the single labels from the strips, which is performed by the movement of the container itself following the application of the label.

The application drum and the transfer drum are continuously operated at a same and constant speed.

Therefore, the strip is not subject to particular stresses due to the intermittent or variable continuous application nor to gluing or breakage problems due to the adhesive layer and perforations in the strip.

In order to ensure the continuous feeding of the strip to the transfer cylinder also during the replacement of the strip reel, DE 10 2014 105 485 proposes forming a loop in the strip which acts as dynamic buffer inside a chamber arranged upstream of the transfer cylinder which unwinds the strip, by means of a pressurized-air jet arranged to blow air onto the strip on the inside of the strip loop, and suction means arranged to draw off the air on the outer side of the loop, in order to keep it with a well-defined form.

This method of forming a loop of strip is complex to manage and not fully effective in preventing gluing of a pre-glued strip and/or breakage of a pre-perforated strip, in particular in the case of feeding of a strip of linerless labels with a predefined speed and tension in an intermittent or variable continuous manner, and therefore subject to starting and stopping and accelerations and decelerations.

The technical problem which is posed therefore is that of providing an apparatus for feeding at high speed linerless labels to means for applying them onto containers of various kinds which solves or at least partially overcomes the aforementioned problems of the prior art.

In connection with this problem it is also required that this apparatus should have small dimensions, be easy and inexpensive to produce and assemble and be able to be easily installed at any user location using normal standardized connection means.

These results are obtained according to the present invention by a method for feeding a strip of linerless labels according to the characteristic features of claim 1 and by an apparatus according to claim 5 for implementing this method.

The present invention relates furthermore to a labeling unit according to the characteristic features of claim 13.

Further details may be obtained from the following description of a non-limiting example of embodiment of the subject of the present invention provided with reference to the attached drawings in which:

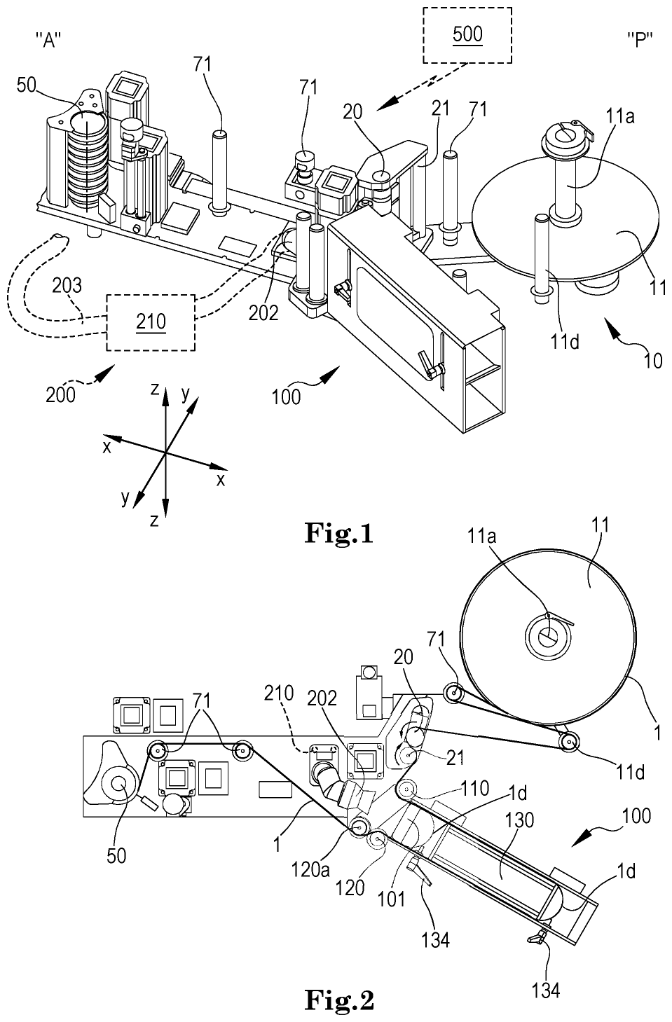

FIG. 1: shows a schematic perspective view of the apparatus according to the present invention;

FIG. 2: shows a first top plan view of the apparatus according to FIG. 1;

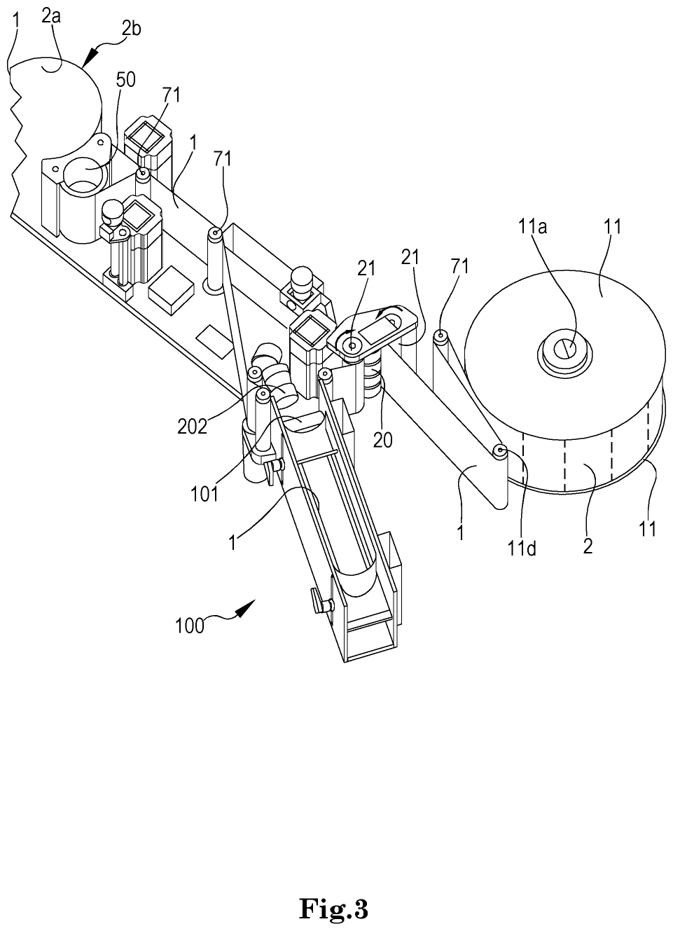

FIG. 3: shows a second schematic perspective view of the apparatus according to FIG. 1 with the strip being fed;

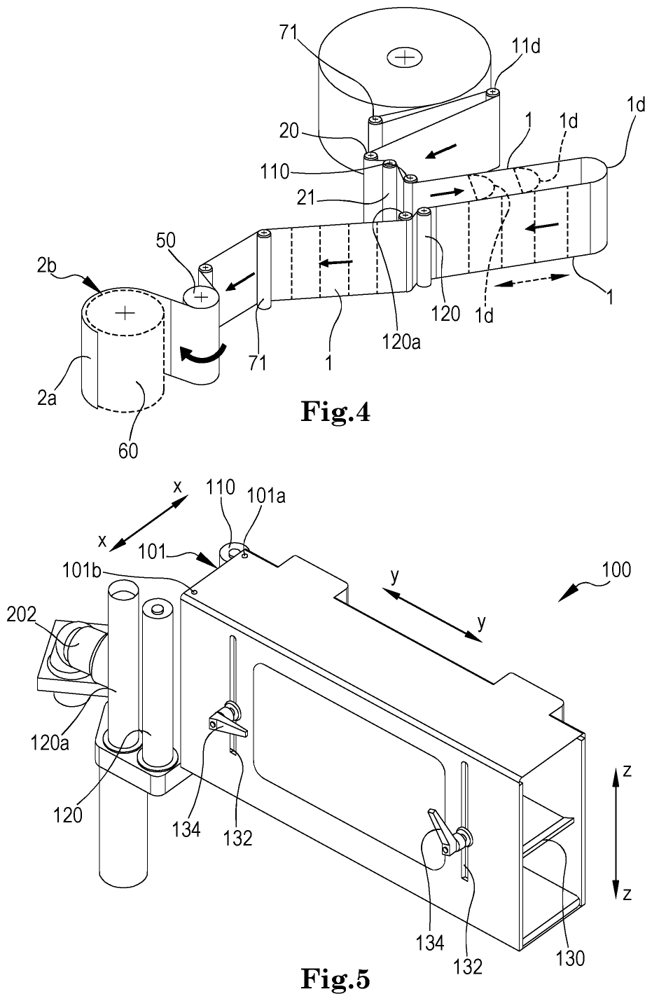

FIG. 4: shows a schematic view of the travel path of the labels inside the apparatus;

FIG. 5: shows a perspective view of the chamber arranged along the travel path of the strip;

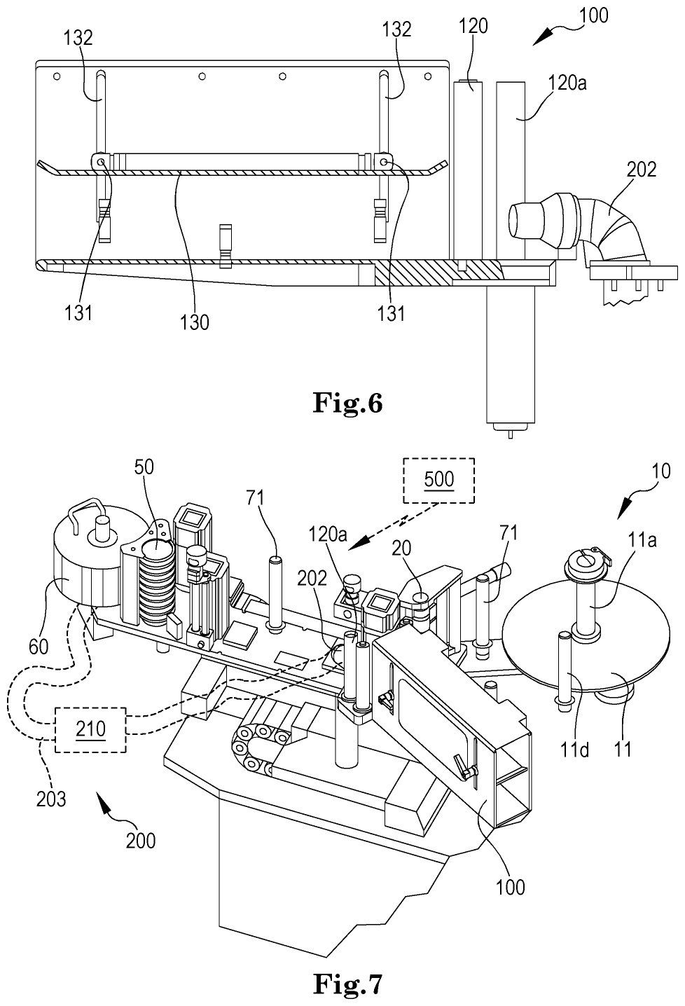

FIG. 6: shows a schematic cross-sectional view, along a vertical plane, of the chamber according to FIG. 5; and

FIG. 7: shows a perspective view of a labeling unit according to the invention.

As shown in FIG. 1 and assuming solely for the sake of easier description and without a limiting meaning a set of three reference axes, respectively extending in a longitudinal direction X-X substantially corresponding to the direction of advancing movement of a continuous strip of linerless labels, transverse direction Y-Y perpendicular to the preceding direction, and vertical direction Z-Z substantially corresponding to the heightwise extension of the strip, a front or downstream part “A” corresponding to the side where the label exits the apparatus and a rear or upstream part “P” opposite to the front part, as well as opposite directions of rotation defined by way of example only for clearer description as clockwise and anti-clockwise, the preferred example of the apparatus according to the invention comprises in its general configuration:

a support 10 arranged at the rear “P” and designed to support a reel 11 containing a strip 1 of linerless labels 2 with an adhesive surface 2a and non-adhesive surface 2b, opposite in the transverse direction Y-Y; a preferred embodiment of said support comprises a plate 11 mounted on a respective idle shaft 11a; preferably, the shaft 11a is connected to a mechanical locking/release brake operated by a pre-winding jockey wheel 11d.

a first motorized drive roller 20, arranged downstream of the reel-holder plate 11; the first drive roller 20 rotates (see FIGS. 3, 4) in a first direction of rotation—anticlockwise direction in the example shown—set to cause unwinding/advancing of the strip 1;

preferably, the first motorized roller 20 is coupled with one or more first opposition counter-rollers 21 for improving the gripping and conveying of the strip inserted between the two rollers;

a second motorized drive roller 50 arranged, during use, upstream of a drum 60 for applying and cutting the single labels, at the front “A” of the apparatus, for feeding the strip of labels 1 to the drum 60;

a plurality of idle transmission rollers 71, arranged between the reel 11 and the second drive roller 50 and designed to guide the strip along its travel path from the reel to the drum 60;

a chamber 100 arranged between the first drive roller 20 and the second drive roller 50 along the travel path of the strip 1; the chamber has an opening 101 substantially adjacent to the zone where the strip 1 passes; in the example shown, the chamber is also open on the opposite side to that of the opening of passage of strip.

At the opposite upstream and downstream edges 101a, 101b of the opening 101 (FIG. 5) there are arranged, respectively, a first, motorized, upstream roller 110 rotating in a first direction of rotation for advancing the strip—in the example shown, anti-clockwise direction—and a second, motorized, downstream roller 120a for rotating in the opposite (clockwise) direction to the direction of the first upstream roller; preferably, the second downstream roller 120a is coupled with a guiding counter-roller 120 arranged upstream of the downstream roller 120a at the downstream edge 101b of the opening 101;

pressurized-air generating devices 200 for generating pressurized air connected to a nozzle 202 arranged at the opening 101 and directed towards the inside of the chamber 100 for supplying pressurized air inside said chamber;

preferably said pressurized-air generating devices comprise a pump 210, the suction mouth 21 of which is connected, by means of an associated duct 203 to the drum 60 for applying and cutting the labels—forming part of the labeling unit (FIG. 7)—in order to generate a vacuum on the side surface of the drum and favour the adhesion of the labels until they become detached when passing over to the container to be labeled for application thereto;

control means 500, for example in the form of an electronic unit which controls one or more electrical drives, designed to cause operation of the motorized rollers in order to obtain advancing of the strip and the generation and supplying of pressurized air, in particular by means of the pump 210 and the nozzle 202; the control means 500 also assume control of synchronization of the said motorized rollers in order to cause advancing of the strip 1.

In greater detail, the first roller 20 is operated so as to cause unwinding and continuous advancing of the strip 1 from the support 10 to the upstream roller 110 of the chamber 100.

The supply of pressurized air from the nozzle 202 towards the inside of the chamber 100 through the opening 101 and the operation of the upstream rollers 110 and/ore downstream rollers 120a,120 of the chamber result in the formation of a loop 1d in the strip inside the said chamber 100. The upstream and downstream rollers of the chamber guide the strip and facilitate the entry/exit thereof into/from the chamber as well as the formation of the loop 1d which remains well-defined, avoiding undesirable gluing together of the opposite inner surfaces of the strip, which are coated with an adhesive layer.

According to preferred embodiments it is envisaged that the first drive roller 20 and second drive roller 50 are operated by drive systems which are independent, but correlated, in particular such that the first drive roller follows the second drive roller.

In particular, it is envisaged that the first drive roller 20 is operated continuously and following the second drive roller 50 which in turn is operated so as to obtain a predefined feeding tension and speed of the strip, which are adapted to the label application and cutting requirements, for example determined by the speed of a (rotating) machine which conveys the containers to be labeled to the label application drum.

The mode and speed of operation of the second drive roller may in particular be set so as to follow the feeding speed of the containers and/or may be varied percentage-wise so as to generate a predefined tension of the strip necessary for cutting thereof.

Preferably, the second drive roller 50 is operated alternately so as to cause intermittent feeding of the strip 1 to the drum 60. However, in some cases, the second drive roller 50 may also be operated continuously (for example in the case of very long labels), with slowing down and acceleration within a label interval determined by the length of the label.

Preferably, the operating speed of the second roller 50 is greater than the operating speed of the first drive roller 20, in particular between 1.5 and 2 times the speed of the first drive roller 20, depending on the length of the labels being processed.

Preferably, the roller 20 feeds the chamber 100 continuously at a variable speed, which is set so as to follow in a suitably parameterized manner the operation of the drive roller 50.

The two motorized rollers 110 and 120a of the chamber are, instead, independent of the drive rollers 50 and 20 and are operated preferably continuously and at a predefined (constant) speed when the roller 50 is in operation, stopping in time when the roller 50 stops or after a predetermined delay.

The formation of the loop 1d allows the advancing movement along the section between the downstream chamber roller and the second drive roller (which must occur at a predefined speed and tension for feeding to the application and cutting drum) to be rendered independent of the unwinding and continuous feeding performed by the first drive roller 20 which unwinds the strip from the reel.

In greater detail, the chamber 100 and the loop 1d allow the tensile load of a reel of linerless—and hence adhesive-coated—labels to be removed from the roller 50 which is thus not subject to heavy loads and therefor better able to adjust the precision of feeding towards the drum, while at the same time reducing the differences between operation of the drive rollers 50 and 20.

Owing to the presence of the upstream roller 110 of the chamber and downstream roller 120a of the chamber in combination with the generation of pressurized air and the unwinding and feeding of the strip by means of the first drive roller 20 arranged upstream of the chamber, the loop 1d moreover remains always well-formed and suitably fed, preventing gluing of the strip of linerless labels and undesirable breakages due to the discontinuous or variable continuous requirement of the second drive roller 50.

Controlling of the tension of the strip and correct feeding thereof at the required high speeds may therefore also be ensured using pre-perforated linerless labels, which are fragile and pre-coated with adhesive and therefore subject to gluing and jamming.

Preferably, the downstream roller 120a of the chamber, which in the presence of the counter-roller 120 will act on the adhesive-coated surface of the strip of labels, is lined with an anti-adhesive material which is designed to prevent adhesion of the strip on the downstream roller 120a.

Similarly, in preferred embodiments, one or more of the other idle rollers 71 or drive rollers 20,50 which come into contact with the adhesive-coated surface of the strip 1 may be lined with anti-adhesive material.

With reference to the configuration described above the operating principle of the apparatus is as follows:

after a reel of the strip 1 has been mounted on the plate 11, the strip is unwound by conveying it across the motorized rollers 20,110,120 and the idle rollers 71 until the free end of the strip becomes engaged with the second drive roller 50;

when a container is present at the drum 60, the control unit 500 activates the drives, causing advancing of the strip driven by the second drive roller 50; correspondingly the first drive roller 20 unwinds the strip 1, based on the requirement of the second drive roller 50, and feeds the strip to the motorized upstream roller 110 of the chamber 100;

the rotation in the feeding direction of the upstream roller 110 of the chamber 100 in combination with the thrust produced by the pressurized air emitted by the nozzle 202 causes the strip to be pushed inside the chamber 100 where a loop 1d is formed and from where it emerges being pulled by the second drive roller 50; the advancing movement of the strip is counteracted by the downstream roller 120a of the chamber 100 which keeps the strip at a predefined tension during the advancing movement between said downstream roller 120a and the second drive roller 50;

as indicated by a broken line, the chamber performs a buffer function with respect to the advancing movement of the strip, causing elongation/shortening of the loop 1d of the strip which is formed inside the said chamber 100 in response to variations in the speed of advancing movement of the said strip following variations in operation of the various component parts of the apparatus and/or the drum 60 of a labeling unit.

It is therefore clear how the apparatus according to the invention:

is particularly suitable for feeding to a drum for performing the application and cutting of linerless labels, owing to the pressurized air which pushes the strip 1 inside the chamber 100 where an air gap is formed between the internal adhesive-lined surfaces of the two strip sections which—in the absence of pressurized air which pushes the strip from the opening 101 towards the inside of the chamber 100 and of the action of the upstream and downstream rollers 110,120a of the chamber—could instead become stuck together, resulting in breakages or interruptions in operation.

The solution allows in particular the creation of a reserve supply of strip sufficient for the second roller 50 which operates intermittently and at a speed set depending on the speed of transit of the bottles to be labeled; in particular, the result is that the first roller 20 is allowed to operate and feed continuously the chamber 100 so as to relieve the roller 50 of driving of the entire reel of labels, this task being left to the roller 20, resulting in a greater speed and reliability of feeding of the labels to the drum 60.

Owing to the use of the same pump or alternative means for generating pressurized air to be supplied towards the inside of the chamber 100 and the simultaneous generation of a vacuum inside a drum of a labeling machine, savings in energy may be achieved and pollution of the surrounding environment due to the emission of foul air may be avoided, resulting moreover in a compact assembly.

According to preferred embodiments it is envisaged that:

the inner surfaces of the walls of the chamber 100 are lined with an anti-adhesive material or, alternatively, having small sliding surfaces so as to facilitate the sliding movement of the strip from the inlet to the outlet of the said chamber; and/or

in a first embodiment, the chamber 100 is provided with fixed dimensions and may be interchanged when there is a variation in the height of the strip 1;

in a second embodiment it is envisaged that the chamber 100 may contain a surface 130 (FIGS. 5,6) movable in a vertical direction Z-Z so as to adapt the height of the chamber to the height of the strip; in this configuration the surface is connected to threaded pins 131 projecting towards the outside of the chamber, in the example shown in the transverse direction Y-Y—through slots 132 in a side wall—and able to be locked in position by means of handles 134 with a female thread or the like.

In tests carried out the apparatus proved to be suitable for feeding labels to a drum of a labeling unit at a speed of 130 m/min.

Although described in connection with a number of embodiments and a number of preferred examples of implementation of the invention, it is understood that the scope of protection of the present patent is determined solely by the claims below.

1. A Method for feeding a strip (1) of linerless labels (2) to a drum (60) for applying the labels onto containers, comprising the following steps:
providing a reel of a strip of linerless labels on a support (10) designed to allow unwinding of the strip (1);
unwinding the strip from the reel arranged on the support (10) and feeding the strip downstream in an advancement direction (X-X) by means of a first motorized drive roller (20), wherein the first drive roller (20) rotates in a first direction of rotation so as to unwind and advance the strip (1);
advancing the strip to a second motorized drive roller (50), designed to rotate in a direction of rotation so as to advance the strip (1) and feed it to a drum (60) for applying and cutting the single labels;
entry and exit of the unwound strip into/from a chamber (100) arranged between the first drive roller (20) and the second drive roller (50) in the advancement direction (X-X) of the strip, with formation of a loop (1d) in the strip inside the chamber (100), the chamber having an opening (101) in a zone where the strip passes, with opposite upstream and downstream edges;
wherein along its advancing path from the reel (11) towards the second drive roller (50) the strip passes through a plurality of idle transmission rollers (71);
wherein the formation of said loop (1d) in the strip inside the chamber is caused by the supply of pressurized air towards the inside of the chamber (100) through the opening (101) and by the operation of a first upstream roller (110) of the chamber, motorized and rotating in the direction of rotation for advancement of the strip (1), and of a second downstream roller (120a) of the chamber, driven so as to rotate in the opposite direction to the first upstream roller, said upstream and downstream rollers being respectively arranged at the opposite upstream and downstream edges (101a, 101b) of the opening (101) of the chamber (100);
and wherein the first drive roller is operated so as to cause continuous unwinding and advancing of the strip (1) from the support (10) to the upstream roller (110) of the chamber (100) and the second drive roller is operated so as to cause an advancing movement of the strip with a predefined speed and tension for feeding towards the drum (60), between said downstream roller (120a) of the chamber (100) and the second motorized drive roller (50).

2. The Method according to claim 1, wherein the second drive roller (50) is operated intermittently or in a variable continuous manner with a speed set to obtain said predefined speed and tension, the speed being in particular set based on a feeding speed of the bottles to be labeled to the drum (60) and/or on a tension of the strip required for cutting thereof.

3. The Method according to claim 1, wherein the first drive roller (20) and the second drive roller (50) are operated in a correlated manner so that the first drive roller follows the second drive roller.

4. An apparatus for feeding a strip (1) of linerless labels (2) to a drum (60) for applying the labels onto containers, comprising:
a strip support (10) for supporting a reel of a strip of linerless labels (2) and allowing unwinding of the strip (1) from the reel;
a first motorized drive roller (20), designed to rotate in a first direction of rotation to cause unwinding of the strip (1) arranged on the support (10) and continuous feeding thereof downstream in an advancement direction (X-X) of the strip;
a second motorized drive roller (50), designed to rotate in a direction of rotation such as to cause advancing of the strip (1) and feeding thereof with a predefined speed and tension to a drum (60) for cutting and applying the single labels onto containers;
a plurality of idle transmission rollers (71) arranged between the support (10) and the first drive roller (20) and/or second drive roller (50) and designed to guide the strip (1) along its advancement path from the reel (11) to the second drive roller (50);
a chamber (100) which is arranged between the first drive roller (20) and the second drive roller (50) in the direction (X-X) of advancement of the strip and which has an opening (101) in a zone where the strip passes, the opening having opposite upstream and downstream edges (101a,101b);
a first upstream roller (11) of the chamber, motorized and rotating in the direction of rotation for advancement of the strip (1), and a second downstream roller (120a) of the chamber, motorized to rotate in a direction opposite to that of the first upstream roller, said upstream and downstream rollers being arranged at a respective upstream or downstream edge of the opening (101) of the chamber (100);
pressurized air generating devices (200) for generating pressurized air, which are connected to a dispensing nozzle (202) arranged to dispense the pressurized air towards the inside of the chamber (100) through the opening (101);
control means (500) designed to cause operation of the motorized rollers so as to obtain advancement of the strip; said control means (500) and said motorized rollers being configured and arranged to cause the unwinding and continuous advancing movement of the strip (1) from the support (10) to the upstream roller (110) of the chamber (100) and an advancing movement of the strip with a predefined speed and tension between said downstream roller (120a,120) of the chamber (100) and the second motorized drive roller (50) for feeding to the drum (60),
wherein dispensing of pressurized air from the nozzle (20) towards the inside of the chamber (100) through the opening (101) and the operation of the upstream rollers (110) and/or downstream rollers (120a,120) of the chamber causes the formation of a loop (1d) in the strip inside the said chamber (100).

5. The apparatus according to claim 4, wherein said support (10) for supporting the reel (11) comprise a plate (11) mounted idle on a respective idle shaft (11a), the support preferably comprising a braking arrangement for braking the idle plate, which are associated with a jockey wheel (11D) of a pre-unwinding device.

6. The apparatus according to claim 4, wherein said first drive roller (20) is coupled with a respective counter-roller (20a) and/or in that said downstream roller (120) of the chamber (100) is coupled with a respective counter-roller (120a).

7. The apparatus according to claim 4, wherein:
the chamber (100) is open also on the side opposite to that of the opening where the strip passes; and/or
the inner surfaces of the walls of the chamber (100) are lined with anti-adhesive material and/or are in the form of small sliding surfaces so as to facilitate sliding of the strip from the inlet to the outlet of the said chamber; and/or
the chamber (100) is interchangeable when there is a variation in the height of the strip (1) or it contains a surface (130) movable in the vertical direction (Z-Z) so as to adapt the height of the chamber to the height of the strip.

8. The apparatus according to claim 4, wherein said second drive roller (50) is operated intermittently or in a variable continuous manner with a speed set to obtain said predefined speed and tension, the speed being in particular set based on a speed of feeding of the bottles to be labeled to the drum (60) and/or on a tension of the strip required for cutting thereof.

9. The apparatus according to claim 1, wherein the first drive roller (20) and second drive roller (50) are operated by drive systems which are independent, but correlated such that the first drive roller follows the second drive roller.

10. The apparatus according to claim 4, wherein the upstream and downstream motorized rollers (110,120a) of the chamber (100) are configured to be operated continuously and at a predefined speed when the second roller (50) is in operation, stopping when the second roller (50) stops or after a predetermined delay.

11. The apparatus according to claim 4, wherein said pressurized-air generating devices (200) comprise a pump (201).

12. The apparatus according to claim 4, wherein said control means (500) are configured to synchronize the rotation of the motorized rollers (20,50,110,120a) for feeding the strip (1) of labels so as to keep the tension of the strip (1) constant along the section between the downstream roller (120a) of the chamber and the second drive roller (50).

13. The labeling unit comprising a rotating drum (60) for cutting and applying linerless labels (2), characterized in it comprises an apparatus for feeding the labels to the drum according to claim 4.

14. The labeling unit according to the claim 13, wherein the side surface of the drum (60) is kept in a vacuum condition so as to allow the labels to adhere thereto during rotation.

15. The labeling unit according to claim 14, wherein the vacuum on the surface of the drum (60) is generated by the same pressurized-air generating devices (200) of the feeding apparatus.

16. The labeling unit according claim 15, wherein the pressurized-air dispensing nozzle is connected to the drum (60) via a duct (203).

17. The process for applying a plurality of linerless labels joined together in the form of a strip wound on a reel to a respective plurality of containers, comprising the steps of:
feeding the strip (1) of linerless labels (2) to a rotating drum (60) for cutting and applying the labels, with a predefined speed and tension by means of a method according to one of claims 1-4;
adhesion of the strip of labels to the surface of the drum with rotation of the drum which drives the strip of labels;
feeding a plurality of containers to a label application zone on the drum;
cutting of a respective label by the drum, so as to separate it from the strip driven by the said drum;
applying the cut label onto a respective container passing through the application zone by means of said rotating drum.
